(19) United States
(12) Patent Application Publication
(10) Pub. No.: US 2017/0228800 A1
(43) Pub. Date: Aug. 10, 2017

(54) SYSTEM FOR FUNDRAISING TRACKING AND SYNCHRONIZATION

(71) Applicant: Elmer Yegin Chen, Charlotte, NC (US)

(72) Inventor: Elmer Yegin Chen, Charlotte, NC (US)

(21) Appl. No.: 15/429,130

(22) Filed: Feb. 9, 2017

Related U.S. Application Data
(60) Provisional application No. 62/293,713, filed on Feb. 10, 2016.

(51) Int. Cl. G06Q 30/02; G06Q 40/06

(52) U.S. Cl. CPC G06Q 30/0279; G06Q 40/06

(57) ABSTRACT

The present invention pertains to a system for fundraising tracking and synchronization. The system comprises a user interface to allow input from a user, a display to display information to the user, a processor to process the input and information, a meeting summarization module to receive fundraising meeting information from the user and prompt the user for fundraising next steps, a tracking module to track fundraising next steps, and a transceiver to transfer information with a server. The system searches for a record of a fundraising meeting, requests a user to input a result of the fundraising meeting; requests the user to input a next step after the fundraising meeting, updates a database with the result of the fundraising meeting, updates the database with the next step after the fundraising meeting, and tracks the next step.

### RELATED U.S. APPLICATION

This application claims priority to the co-pending U.S. provisional patent application, Ser. No. 62/293,713, Attorney Docket Number EYC-01, entitled “METHOD AND APPARATUS FOR ENHANCED MEETING TRACKING AND COMMUNICATIONS,” with filing date Feb. 10, 2016 which is incorporated by reference herein in its entirety.

### FIELD OF THE INVENTION

The present invention relates to mobile device and database to enhance meeting effectiveness. More particularly, the present invention pertains to a system for fundraising tracking and synchronization.

### BACKGROUND

Fundraising represents a critical function in many for-profit and not-for-profit organizations, especially for investment managers. For these organizations, fundraising represents a high-stakes, laborious, lengthy, and expensive process. Investment management firms typically employ dedicated employees, consultants, or outsourced firms as fundraisers. These fundraisers utilize their knowledge and relationships of eligible investors, typically other organizations but sometimes individuals, to secure investment commitments into a particular fund being raised. Particularly to raise large funds focused on alternative investments such as private equity or hedge funds from institutional investors such as pensions and foundations, this process can be characterized as relationship-based and requiring many months or even years.

The market currently features software packages catering to private equity GPs and LPs. They tend to be desktop-based software sold on a subscription basis attempting to provide a comprehensive solution.

What is needed is a system for meeting tracking and synchronization to support fundraising. Furthermore, the system should have wireless capability to support users outside the office.

### SUMMARY

The present invention pertains to a system for fundraising tracking and synchronization. The system comprises a user interface to allow input from a user, a display to display information to the user, a processor to process the input and information, a meeting summarization module to receive fundraising meeting information from the user and prompt the user for fundraising next steps, a tracking module to track fundraising next steps, and a transceiver to transfer information with a server.

Under another embodiment of the present invention, the system can comprise a prospect identification module to identify a fundraising prospect based on fund characteristics and investor characteristics. The system can comprise a prospect quantification module to estimate a probability of investment from a fundraising prospect. The system can comprise a meeting preparation module to collect information for a fundraising meeting. The system can comprise a database interface module to search a database for information stored on said database. The system can comprise a database interface module to update information stored on a database.

Under another embodiment of the present invention, the system searches for a record of a fundraising meeting, requests a user to input a result of the fundraising meeting; requests the user to input a next step after the fundraising meeting, updates a database with the result of the fundraising meeting, updates the database with the next step after the fundraising meeting, and tracks the next step.

Under another embodiment of the present invention, the system can identify a fundraising prospect from eligible investors for a fund. The system can identify a fundraising prospect from eligible investors for a fund by matching characteristics of the fund with portfolio needs of eligible investors. The system can calculate a likelihood of a fundraising prospect investing into a fund. The system can calculate an estimated investment amount from a fundraising prospect into a fund. The system can collect information to prepare the user for the fundraising meeting. The system can transmit a reminder to the user for the next step. The system can transmit a reminder to the user to send a private placement memorandum. The system can use multivariate regression to calculate a likelihood of a fundraising prospect investing into a fund. The system can use multivariate regression to calculate an estimated investment amount from a fundraising prospect into a fund. The system can associate a photograph to a record of a participant of the fundraising meeting. The system can store an image of a business card of a participant of the fundraising meeting. The system can request the user to input information learned from the fundraising meeting and store the information in the database. The system can request the user to input potential investment amount from a fundraising prospect and store the potential investment amount in the database. The

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a diagram showing an exemplary fundraising tracking and synchronization system of one embodiment of the present invention.

FIG. 2 is a diagram showing an investment fundraising funnel utilized and supported by an exemplary fundraising tracking and synchronization system of one embodiment of the present invention.

FIG. 3 is a flow diagram showing an exemplary fundraising tracking and synchronization of one embodiment of the present invention.

FIG. 4 is a flow diagram showing an exemplary finding prospects process of one embodiment of the present invention.

FIG. 5 is a flow diagram showing an exemplary quantifying prospects process of one embodiment of the present invention.

FIG. 6 is a flow diagram showing an exemplary prepare for meeting process of one embodiment of the present invention.

FIG. 7 is a flow diagram showing an exemplary summarizing meeting process of one embodiment of the present invention.

FIG. 8 is a flow diagram showing an exemplary track next steps process after a meeting or similar interaction of one embodiment of the present invention.

FIG. 9 is a flow diagram showing an search and update database process of one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

Under one embodiment of the present invention, the mission of enhancing the efficiency of private market investment fundraising is accomplished. The strategy involves developing software and mobile apps to reduce inefficiencies in a high-stakes, laborious, lengthy, and expensive fundraising process.

Pensions, endowments, foundations, and high net worth individuals in the U.S. alone invest some $300+billion into private market fund investments each year. These fund investments take the form of private equity funds (including buyout funds and venture capital funds), private real estate funds, and private debt funds.

A typical investment firm will spend 18-24 months raising $200 million-$5 billion for a fund that will be invested within 3-5 years. Then if the firm is successful, the cycle must repeat itself, as the firm raises the next fund to invest.

The fundraising process often involves several of the fund's partners and fundraisers (both internal and outsourced) identifying potential investors; accessing them; convincing the investors to back the fund; and completing due diligence, negotiations, and fund “closing”. The fundraisers typically have a universe of 1,000-2,000 potential investors, of which they may contact 500, from which they may meet 200-300 (many of them multiple times), enter into serious discussions with 75-100, and end up with investments from 25-50 limited partners.

At any point in time, there are an estimated 3,000 institutional-quality funds (those seeking at least $100 million) on the market seeking investors. A significant portion of them will not raise sufficient capital to go into or stay in business, and go out of business or subsequently cease operations.

Out-of-pocket fundraising expenses for the fund manager may run several million dollars per fund raised. In addition, the fund manager often incurs substantial costs of an internal investor relations/fundraiser staff plus the significant opportunity costs of the time of several senior partners committed to the fundraising effort. Limited partners typically invest from $10 million to $100 million into each fund.

Inefficiencies in the fundraising process stem from structural factors such as:
1) Heterogeneity of the funds, including their strategies, terms, etc.;
2) An asynchronous market, in which funds are often available in different years;
3) Considerable heterogeneity of limited partners, including their potential interest in a given fund, investing preferences, decision processes, knowledge of the opportunity set, etc.;
4) Lack of transparency about limited partner likelihood of investment and likely investment amount.

As a result, the process is characterized by:
1) High search costs and time incurred by fund managers in searching for potential investors, and limited partners in searching for suitable funds;
2) “High-touch” process involving extensive time commitment of senior people;
3) High transaction costs, with several intermediaries involved in the process;
4) Non-standardization of investment terms.

Potential tools to make the fundraising process more efficient include:

1) Information resources to boost efficiency of fundraising;
2) Reducing search costs by predicting limited partner behavior;
3) Software and/or apps for enhanced tracking of meetings in the fundraising and/or investor relations process.
4) Software and/or apps for enhanced tracking of meetings and follow-up steps between those seeking funds and those investing feeds, including but not limited to communications subsequent to a fundraising-related meeting.

Under one embodiment of the present invention, a wireless app is used to support fundraising. There is currently no known way to help private equity GPs, particularly fundraisers, where they most often find themselves—on a business trip. This situation calls for an app that can be used on an iPhone or Smartphone that can quickly and simply record data that will later be fed into a more comprehensive database.

Generally, fund raisers hold several meetings during every business trip, with many meetings resulting in various notes taken down in a paper notebook. By the time the notebook typically gets reviewed (when the business trip is over and the professional has returned to the office), several days have passed, rendering some immediate action items, impressions, etc. at risk of being forgotten.

A more efficient manner would be an iPhone or Smartphone app that could be quickly accessed after (or during) a meeting with a prospective investor. This app would quickly record meeting details—while they are still fresh—in a standardized format. This data would be readily downloadable to a larger software program or analyzed on a standalone basis.

Under one embodiment of the present invention, a potential app or software comprises traditional, formal design for meeting tracking. Sample questions to record answers to:

On 1 (worst) to 5 (best) scale:
Overall meeting effectiveness
Likelihood of investing

If ‘high’, type in potential amount and timeframe

Typed-in responses
GP attendees
LP attendees
Meeting location
Meeting date
Next steps: (buttons to select)

None

Dataroom access

Send materials

Site visit

Subscription agreement

Fund strengths in LP's view (buttons to select)
Investment approach
Reputation
Track record

Fund weaknesses in LP's view (buttons to select)
Aspects of track record
Team stability
Strategy

The app would then allow ready export of data to a larger desktop-based CRM or fundraising software package, or possibly compute analytics to assess fundraising strategy effectiveness.

Under one embodiment of the present invention, a potential app or software comprises modern, casual approach to meeting tracking. Shown in sample screens which follow a sequence to populate a basic database below.

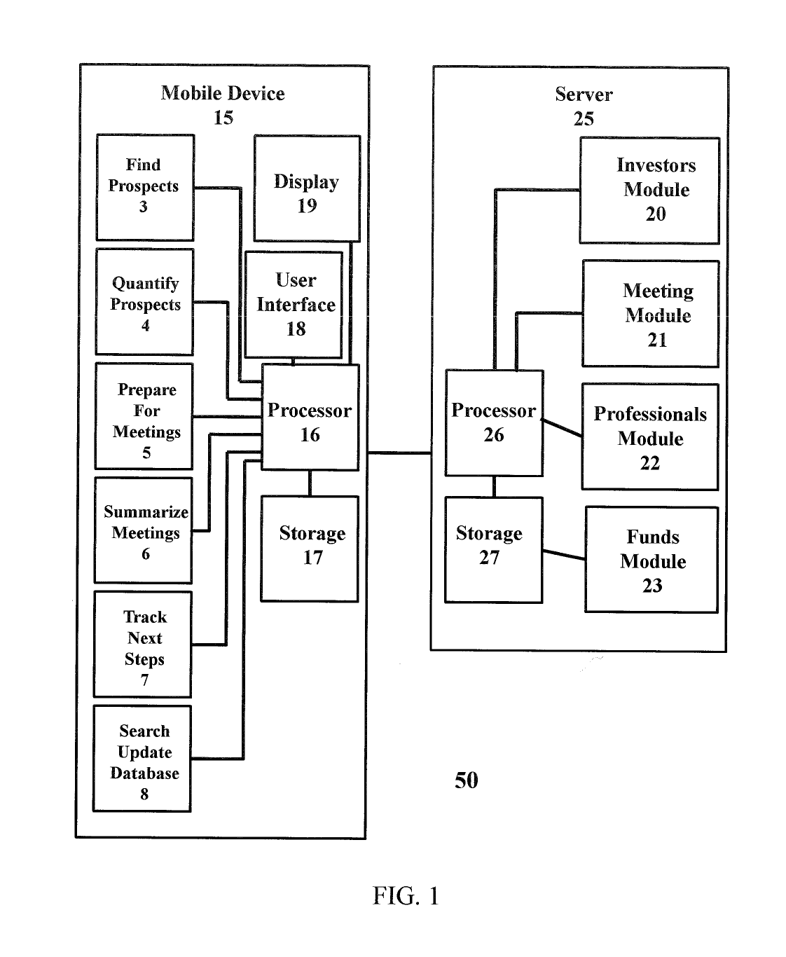

FIG. 1 is a diagram showing an exemplary fundraising tracking and synchronization system of one embodiment of the present invention. In this embodiment, fundraising tracking and synchronization system 50 can comprise mobile device 15 and server 25. Mobile device 15 can be coupled to server 25 through a local area network (LAN), wifi, cellular network, 4G LTE network or other wireless network. Mobile device 15 comprises a wireless transceiver to communicate or transfer data or information with server 25. Mobile device 15 can be a mobile phone, smartphone, smartphone with Android operating system, smartphone with iOS operating system, laptop, notebook or tablet. Mobile device 15 can comprise processor 16, storage 17, user interface 18 and display 19. Processor 16 can be coupled to storage 17, user interface 18 and display 19. Storage 17 can be a flash drive or hard drive. User interface 18 can be a touch sensitive screen, keyboard, mouse, voice activated control device or remote control device. Display 19 can be a liquid crystal display (LCD) or other display. Mobile device 15 can comprise Find Prospects Module 3, Quantify Prospect Module 4, Prepare for Meetings Module 5, Summarize Meetings Module 6, Track Next Steps Module 7, and Search/Update Database Module 8. Processor 16 can be coupled to Find Prospects Module 3, Quatify Prospect Module 4, Prepare for Meetings Module 5, Summarize Meetings Module 6, Track Next Steps Module 7, and Search/Update Database Module 8. Server 25 can comprise processor 26 and storage 27. Processor 26 can be coupled to storage 27. Storage 27 can be a flash drive or hard drive. Server 25 can comprise Investors Module 20, Meeting Module 21, Professionals Module 22 and Funds Module 23. Processor 26 can be coupled to Investors Module 20, Meeting Module 21, Professionals Module 22 and Funds Module 23.

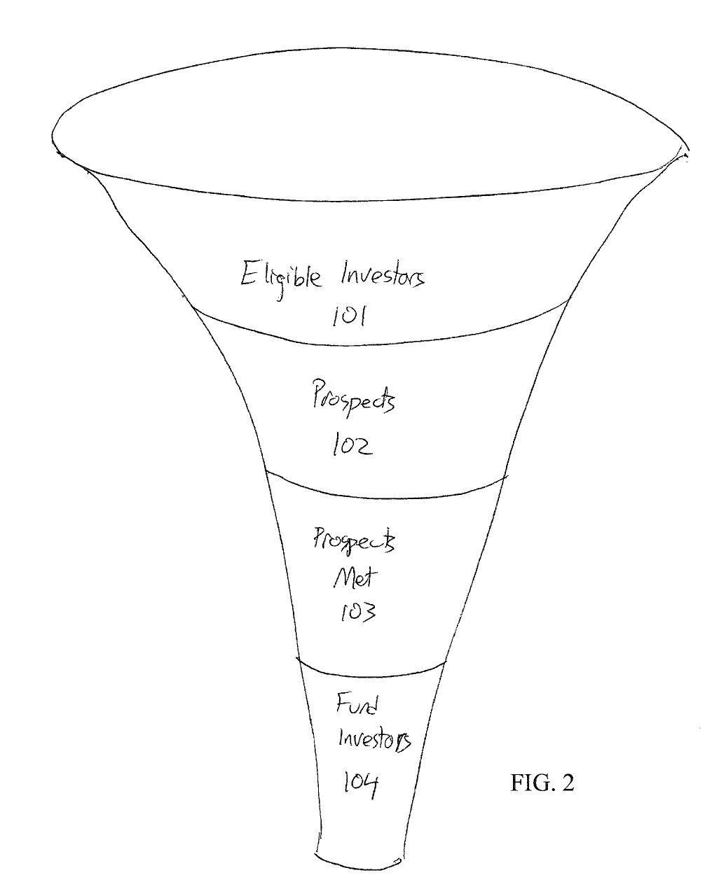

FIG. 2 is a diagram showing an investment fundraising funnel utilized and supported by an exemplary fundraising tracking and synchronization system of one embodiment of the present invention. FIG. 2 shows the relationship among many eligible investors 101, the smaller number of prospects identified from those eligible investors 102 by the fundraiser and system 50, the prospects met with 103 by the fundraiser during the fundraising process, and typically an even smaller number of fund investors 104 that ultimately decide to invest in, or commit to invest in, a particular fund.

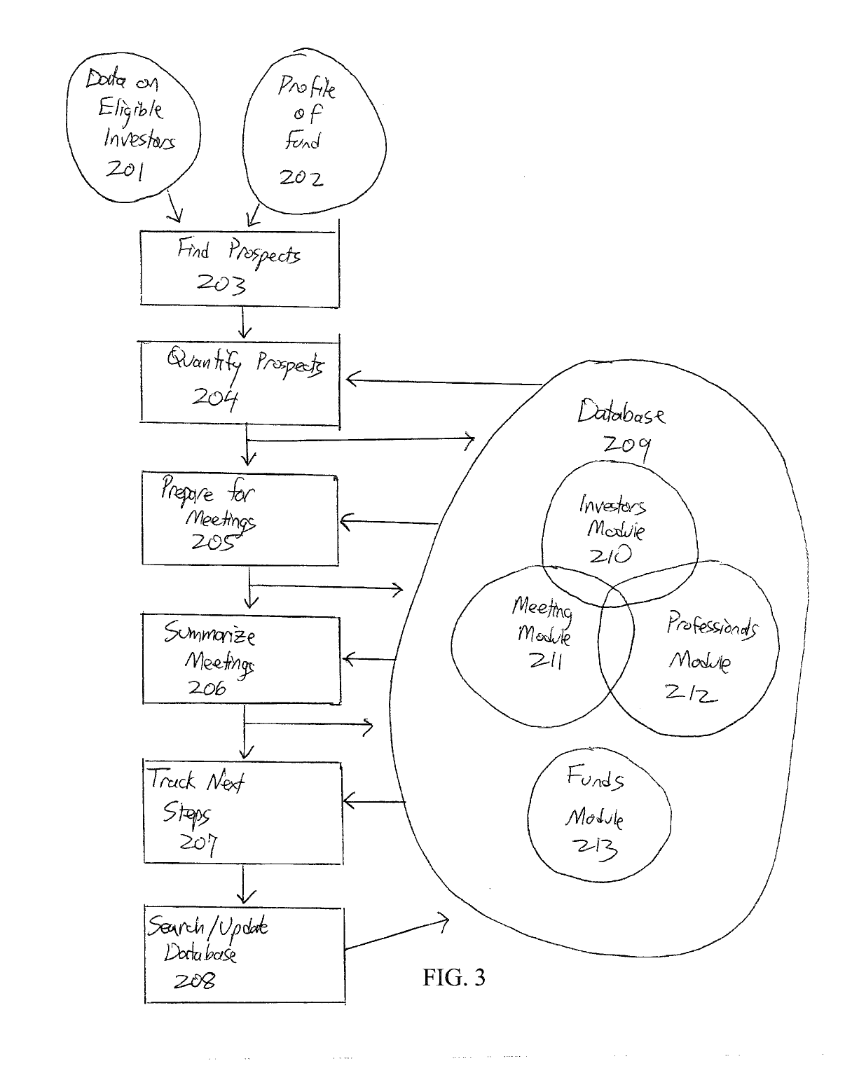

FIG. 3 is a flow diagram showing an exemplary fundraising tracking and synchronization of one embodiment of the present invention. Data on Eligible Investors 201 and Profile of Fund 202 can be inputs into the six functions, or modules, of one embodiment of the present invention: finding prospects 203, quantifying prospects 204, preparing for a meeting 205, summarizing a meeting 206, tracking the next steps of meetings 207, and searching and/or updating the database 208. Database 209 can store results from the inputs as well as information gathered during meetings. Database 209 can store four different data types in different modules, comprising Investors Module 210 or data on organizations, Meetings Module 211 or data on interactions, Professionals Module 212 or data on people, and Funds Module 213 or data on funds being raised by the fundraiser. Investors Module 210, Meetings Module 211, and Professionals Module 212 can comprise overlapping data and may cross-reference each other. FIG. 3 also shows feedback loops that adjust the predictive model's outputs over time employing machine learning and similar techniques, as the Database 209 gradually grows to comprise expanded and updated data gathered during meetings. In turn, Database 209 can produce more accurate results from Quantify Prospects 204 when activated during future fundraising efforts for future funds.

System 50 can support investment industry fundraising. System 50 can comprise a quantitatively-driven predictive model incorporated into a meeting management database and calendar application. Upon activation, mobile device 15 can present a homepage or initial screen with modules for the user to select from as follows:
Homepage/Initial Screen
Select the Routine that you would you like to use:

Find Prospects

Quantify Prospects

Prepare for Meeting

Summarize a Meeting

Track Next Steps

Search/Update Database of Meetings
Today is DATE. It is now TIME pm.
You have 1 follow-up today.

The modules can comprise Find Prospects 203, Quantify Prospects 204, Preparing for Meetings 205, Summarize Meetings 206, Track Next Steps 207, and Search/Updating Database 208. Mobile device 15 can displays a bar for reminder notices on the bottom of the homepage, including the time/date and any follow-ups needed for that day. Mobile device 15 can request and receive input from the user through user interface 18 the module to proceed to. Mobile device 15 then calls up the selected module.

Prepare for Meetings 205 can provide concise information on both the organization and the organization's professionals involved in a meeting. It can draw upon public information sources as well as the proprietary database that the fundraiser has built over time through repeated interactions with the prospect organization and/or the individual professionals involved in a meeting.

Summarize Meetings 206 can capture key prospect facts, relevant metrics for converting the prospect into a fund investor, and follow-up steps from the meeting. By being app-enabled and accessible from a wireless device, Summarize Meetings 206 can serve fundraisers while they are still on a fundraising business trip meeting several prospects, before they return to the office where their desktop computers are located. In that manner, the information is still fresh in their mind and more accurately recorded. The information recorded in this module plays an important role in initiating and updating, over a multi-year period, the fundraiser's proprietary database of prospects. A tangible form of the fundraiser's relationship network, this database—particularly when maintained and updated over time by the fundraiser—has the potential to make a particular fundraiser's predictive model more accurate than a competitor's. A particular fundraiser's model will likely be more accurate if Summarize Meetings 206 or Database 209 (1) contains more up-to-date information about eligible investors and their preferences, and (2) captures more relevant metrics—garnered through the fundraiser's experience and through machine learning or similar techniques—that may predict propensity to invest.

In particular, Summarize Meetings 206 or Database 209 can address a common obstacle to fundraising effectiveness—the fundraiser's difficulty with remembering all the faces and names of meeting participants, particularly the less senior people, over time. Often, several weeks after a meeting with several participants, the meeting participants each have several business cards from the meeting, but little recollection as to what faces were associated with which business cards. Being able to more readily associate faces with names and business cards will enhance a fundraiser's effectiveness.

Track Next Steps 207 can display the upcoming follow-up actions to progress the fundraising process—such as a phone call or further meeting—expected of the fundraiser, either for a particular prospect, or several/all prospects within a specified time period. Fundraising typically involves a multi-quarter or multi-year process with numerous phases and prospects that may number in the hundreds. Prospects also may have different timelines and procedures for different parts of the process. Next steps for prospects after a meeting with a fundraiser display considerable heterogeneity. Accurately tracking these next steps and working to synchronize both prospect and fundraising organization's timelines are important to a fundraiser's success.

Search/Update Database 208 can allow mobile device 15 to receive input from the fundraiser about search terms of interest, such as names of organizations, professionals, or dates. With this input, mobile device 15 or server 25 can then seek a match between the search term and matching terms in the fundraiser's proprietary record of prospects (generally organizations), professionals (the investment people affiliated with the prospect organizations), and meetings (the fundraiser's interactions with either the prospect organizations or professionals over time). As fundraising is a relationship business more than a transaction business, being able to access information and personal details garnered over a fundraising career that may span a decade or more can prove critical to a fundraiser's success. In particular, many professionals working for prospects change their role within a prospect organization or change employers over time. Effective fundraisers are able maintain those personal relationships over time even if the professionals change roles or affiliations. Having records incorporating photographs and similar media in Database 209 facilitates recall and relationship maintenance.

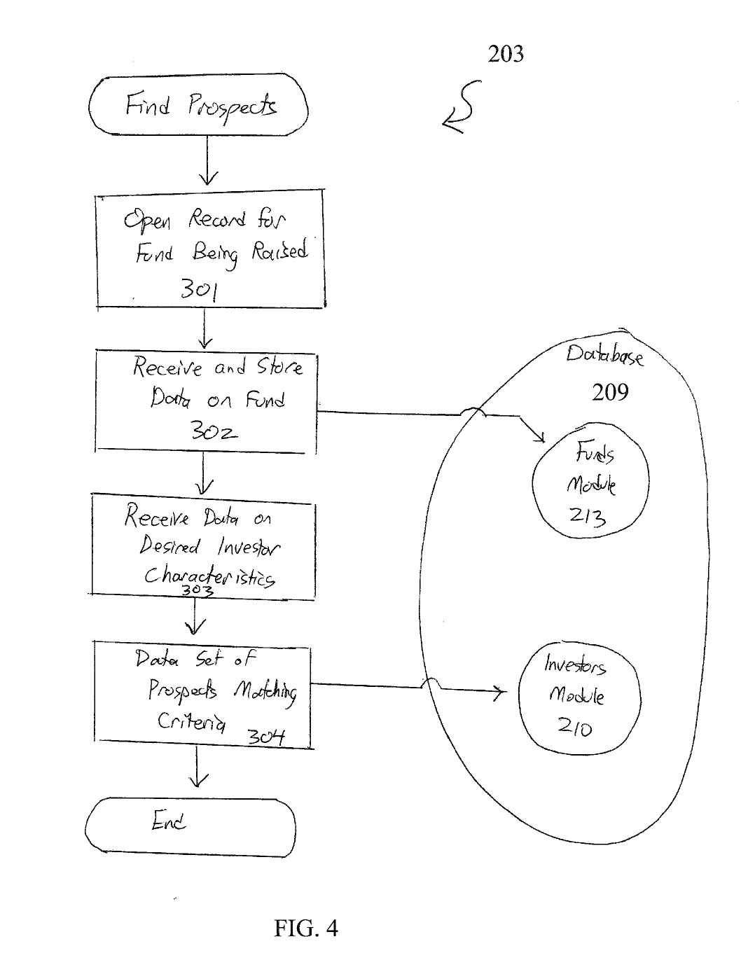

FIG. 4 is a flow diagram showing an exemplary finding prospects process of one embodiment of the present invention. When mobile device 15 receives input to initiate Find Prospects 203, it identifies prospects from the universe of eligible investors suited for a particular fund being raised. Find Prospects 203 interacts with two modules of Database 209—Fund Module 213 and Investors Module 210. Find Prospects 203 can employ a matching methodology, drawing on characteristics of both the fund being raised and the investors being sought.

Identification of prospects possessing characteristics such as typical investment amount, type of organization, and geographic location plays an important early step in the fundraising process. Screening the universe of eligible investors 101 down to prospects 102 with attributes desired by the fundraiser has traditionally been a one-way manual process. The fundraiser can employ a public database or personal relationship list of eligible investors, and employs non-systematic judgments or rules-of-thumb to identify prospects. In one embodiment of the present invention, use of both Fund Module 213 and the Investors Module 210 represents a partially automated, bilateral process that is more systematic.

After mobile device 15 receives input to initiate Find Prospects 203, mobile device 15 opens a record for a particular fund being raised 301 and collects information through the user interface 18 on the fund being raised 302. This information is subsequently employed to determine the extent of a match between the fund being raised and the portfolio needs of eligible investors.

Mobile device 15 or Receive and Store Data on Fund 302 can receive input on the fund being raised, including:
Name of Fund Being Raised;
Strategy of Fund Being Raised—mobile device 15 or Receive and Store Data on Fund 302 can receive input from menu of major categories, such as Private Equity, Private Real Estate, Private Infrastructure/Real Assets, and Private Debt;
Assets Under Management (AUM) in the Fund's Strategy;
Total Assets Under Management of the Investment Manager;
Locations of Offices of Investment Manager Relevant to Strategy;
Targeted Geography of Fund—mobile device 15 or Receive and Store Data on Fund 302 can receive input from menu of major categories, such as U.S. only, U.S. and Europe, Asia, CEE, Latin America, global, etc.;
Fund Size—mobile device 15 or Receive and Store Data on Fund 302 can receive input on targeted fund size in terms of millions of dollars or similar measure;
Targeted Total Annual Net Returns—mobile device 15 or Receive and Store Data on Fund 302 can receive input from menu of major categories, such as Up to 10%, 11-15%, 16-20%, 20+%, or receives input on an exact figure;
Targeted Total Annual Cash Yields—mobile device 15 or Receive and Store Data on Fund 302 can receive input from menu of major categories, such as 0%, 1-4%, 5-8%, 9+%;
Co-Investments—mobile device 15 or Receive and Store Data on Fund 302 can receive input on expected availability of co-investments;
Launch Date—mobile device 15 or Receive and Store Data on Fund 302 can receive input on month and year that fund documentation will be available;
Expected Final Close Date—mobile device 15 or Receive and Store Data on Fund 302 can receive input on month and year that fundraising for particular fund will finish.
After receiving input on these fields, mobile device 15 or Receive and Store Data on Fund 302 can then create and store a record for that fund in the Database 209 in Fund Module 213.

Mobile device 15 can then proceed to receive input from the user interface 18 regarding the characteristics of investors sought for the fund 303. Mobile device 15 can request and receive input on the parameters for the fundraising prospect search for that fund, including but not limited to the following:
Type of institution—mobile device 15 or Receive Data on Desired Investor Characteristics 303 can receive input on types of prospects from a menu that includes major categories such as Sovereign Wealth Fund, Public Pension, Endowment, Foundation, Corporate Pension, Fund of Funds, Family Office, Individual, and Other, for example.
Location—mobile device 15 or Receive Data on Desired Investor Characteristics 303 can receive input on geographic locations of home bases of prospects from a menu that includes Western U.S., Eastern U.S., Southern U.S., Canada, Latin America, Europe, Middle East, Asia, and Other, for example.
Geographies of Investment—mobile device 15 or Receive Data on Desired Investor Characteristics 303 can receive input on geographic locations of geographies that prospects are seeking investments in, from a menu that includes Western U.S., Eastern U.S., Southern U.S., Canada, Latin America, Europe, Middle East, Asia, and Other, for example.
Minimum investment amount—mobile device 15 or Receive Data on Desired Investor Characteristics 303 can receive input on minimum acceptable investment amount per prospect from a menu that includes Up to $1 million, $1-5 million, $6-10 million, $11-25 million, $26 million+. The ranges can be customized by the user.
Target fund size(s)—mobile device 15 or Receive Data on Desired Investor Characteristics 303 can receive input on each prospect's desired fund size or sizes from a menu that includes Up to $100 million, $101-500 million, $501-999 million, $1 billion-$4.99 billion, $5-9.99 billion, and $10 billion+. The ranges can be customized by the user. Investing Characteristics—mobile device 15 or Receive Data on Desired Investor Characteristics 303 can receive input on prospect investing characteristics from a menu that includes menu choices including but not limited to Will/Will Not Invest in First Time Fund, Will/Will Not Be Anchor Investor, Will/Will Not Invest in First Close, Prefers to Invest in First Close/Final Close, Prefers/Indifferent to Co-Investments, etc.

After receiving input on desired prospect characteristics through the user interface 18, mobile device 15 can then search public and proprietary data sources, including industry data sources and the fundraiser's own database, on eligible investors to screen for prospects meeting the selected criteria from the universe of eligible investors. Mobile device 15 can then produce—using database criteria screening methods—and displays a data set of prospects matching the criteria 304 that mobile device 15 had received input for. Mobile device 15 can create records in Investor Module 210 for each of these prospects. This process represents the transition of Eligible Investors 101 to Prospects 102.

In displaying this data set, mobile device 15 first outputs a table that provides the following information on the search parameters:
Name of Fund Being Raised
Strategy
Fund Size
Desired Types of Fund Investors
Desired Geographies of Fund Investors
Desired Minimum Investment Size
Desired Investing Characteristics

Mobile device 15 can then display the data set of prospects matching the search parameters 304. For each prospect, mobile device 15 can present information that may include, but not be limited to, the following, to the extent available:
Name of Prospect
Probability of Investment
Likely Investment Amount
Type of Fund Investor
Location
Strategies of Investment
Minimum Investment Amount
Target Fund Sizes
Investment Characteristics
Investment Volume in the Last 12 Months
Fund Investor in Previous Funds from Fundraiser?

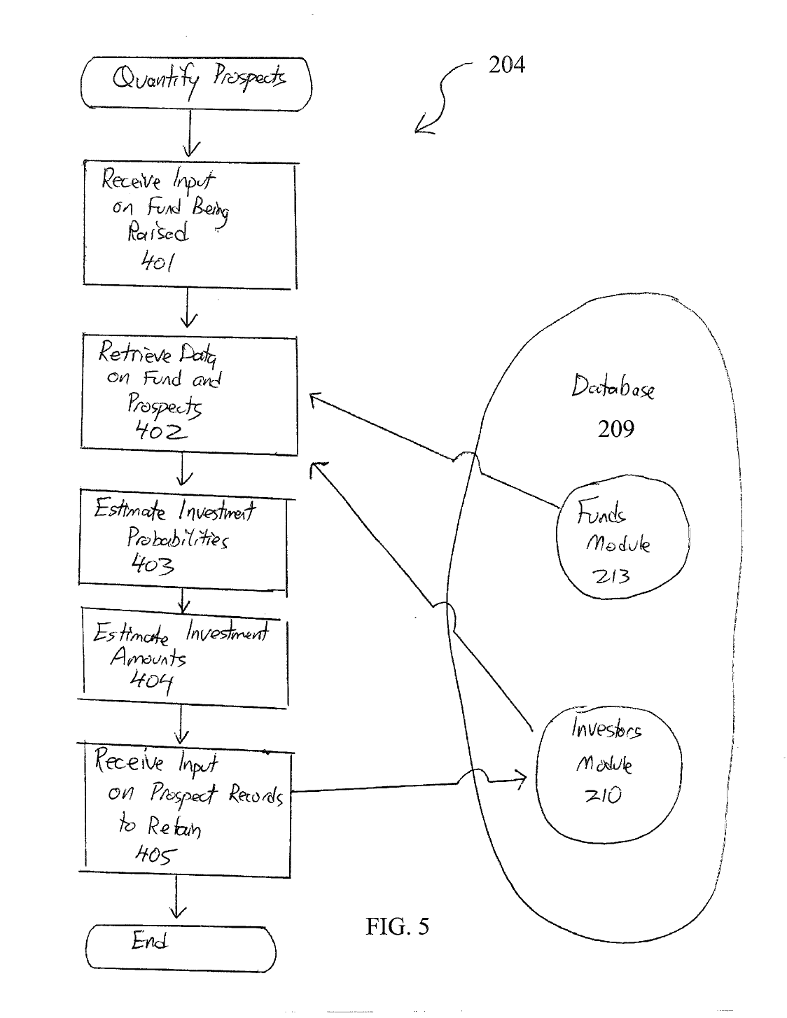

FIG. 5 is a flow diagram showing an exemplary quantifying prospects process of one embodiment of the present invention. The quantification of prospects' likelihood of investing plays an important role at the beginning of the fundraising process as well as toward the latter stages. Accurate prediction of prospects' interest in investing in a fund plays a key role in the fund raising process, particularly in terms of optimizing the allocation of fundraising resources. Accurate prediction of prospects' interest in investing in a fund also enhances the efficiency and satisfaction of the fund subscription allocation process, particularly for raising funds for which investor demand exceeds the supply of available fund allocation.

Similarly, the quantification of prospects' expected investment amounts plays an important role at the beginning of the fundraising process as well as toward the latter stages. The prediction of prospects' expected amounts of investment in a fund plays a key role in the fund raising process, particularly in terms of optimizing the allocation of fundraising resources, and also enhances the efficiency and satisfaction of the fund subscription allocation process, particularly for raising funds for which investor demand exceeds the supply of available fund allocation. The expected investment amounts factor in the likelihood of investing as well as the amount of any investment.

To compute these two estimates, Quantify Prospects 204 can employ statistical analysis particularly multivariate regression models, such as probit and Tobit analysis. More advanced quantitative techniques employing big data analytics, machine learning techniques, and the like could also be employed. Quantify Prospects 204 can employ data both public and proprietary to the fundraiser, in order to (1) employ a predictive analytical model to quantify the probability that a given prospect will invest in the fund being raised (ie, become a fund investor), based on a series of quantitative and qualitative data from the public and proprietary data sets; and (2) employ a slightly different predictive analytical model to quantify the amount that a given prospect will invest in the fund being raised, based on a similar, but not necessarily identical, series of quantitative and qualitative data from the public and proprietary data sets.

Upon receiving input to begin or in continuation of Find Prospects 203, Quantify Prospects 204 receives input on the name of the fund being raised 401. Mobile device 15 or Quantify Prospects 204 can then retrieve information 402 from the Database 209, particularly from Fund Module 213 and Investor Module 210, relevant to that fund and the prospects previously identified in Find Prospects 203 as being potential investors in that fund.

Mobile device 15 or server 25 can then compute and display a numerical estimate of (1) each prospect's probability of investment, the probability becoming a fund investor in the fund being raised 403, based on analytical techniques including but not limited to multifactor econometric/statistical regression analyses, and (2) each prospect's estimated investment amount, the likely investment amount in the fund being raised 404, based on analytical techniques including but not limited to multifactor econometric/statistical regression analyses. These probabilities and estimated investment amounts are intended to serve as inputs to the fundraising user's efforts to prioritize resources in arranging meetings and other fundraising steps.

The estimate of each prospect's probability of investment in the fund being raised 403 is a numerical score from 0% to 100%. The initial probability estimates come from parameters estimated employing publicly-available and commercially-available data, which can serve the routine that training data does. Future probability estimates are made using parameters estimated with additional data proprietary to the fundraiser, as discussed for the feedback loop of FIG. 3.

The data proprietary to the fundraiser is garnered over the course of the fundraiser's numerous meetings with numerous prospects over time. This data proprietary to the fundraiser comprises of (1) updated data (such as a new asset allocation) learned during meetings useful to predicting a prospect's probability of investment that is more accurate than older publicly-available data, and (2) additional information useful to predicting a prospect's probability of investment not readily reflected in publicly-available data but learned during meetings (such as some prospects' preferring to invest in funds run by alumni of certain investment banks).

The basic process used to categorize and quantify a likelihood of investing employs quantitative and qualitative factors from public, proprietary, and personal information sources. It employs a multifactor econometric/statistical regression analysis along the following broad dimensions. The exact type of analysis and methods used may vary as the model becomes better refined, and it is expected that regularization techniques would be used to prevent models from overfitting the data.

Mobile device 15 or server 25 can use a probit model analysis, or similar method, to estimate:

Pr (yᵢ=1|xᵢ)=φ(x′ᵢβ)
Where:
Pr denotes probability of an event.
The binary variable yᵢ=1 represents the state of the world in which a particular prospect i becomes a fund investor, while yᵢ=0 represents the state of the world in which a particular prospect i does not become a fund investor. The subscript i serves to identify each of n prospects, such that i ranges from 1 to n, inclusive.
xᵢ is a vector of dimensions T×1, consisting of T−1 independent explanatory variables believed to influence yᵢ plus an intercept term. Each particular prospect i will have a set of observations of explanatory variables xᵢ.
β is a vector of dimensions T×1, consisting of the coefficients βj to be estimated and the subscript j serving to identify each coefficient βj such that j ranges from 1 to T, inclusive. Pr denotes probability and Φ is the Cumulative Distribution Routine of the standard normal distribution.

The observations of the binary variable y and the vector of observations of explanatory variables xᵢ will initially be populated from publicly available data. With the populated observations, the vector β of parameters can be estimated with maximum likelihood estimation or similar methods.

Over time, each fundraiser will be able to add more observations of yᵢ and xᵢ based on the fundraiser's own meetings, observations, industry intelligence, etc. Each fundraiser may also be able to modify the vector of explanatory variables to be greater than or less than T variables based on experience or predictive power of the additional variables.

For the purposes of one embodiment of the present invention, the vector xᵢ will have five major categories of numerical and binary dummy variables that measure the following characteristics:
Variables describing the prospect's general characteristics, and prospect's characteristics relevant to fund's strategy and geography:
Type of prospect (dummy variables indicating public pension, corporate pension, endowment, individual, etc.),
Prospect's assets under management,
Prospect's years of experience investing,
Prospect's target allocation for fund's strategy,
Prospect's actual allocations made to fund's strategy and geography;
Variables describing the prospect's overall investment team characteristics, and prospect's investment team characteristics relevant to fund's strategy and geography:
Size of investment team at prospect;
Size of investment team relevant to fund's strategy;
Use of non-discretionary consultant (dummy variable);
Tenure of the prospect's chief investment officer.
Variables describing the relationship between the fundraiser's organization and the prospect:
Number of previous funds that the prospect has invested in from the fundraiser's organization;
Number of previous funds in fund's strategy that the prospect has invested in from the fundraiser's organization;
Number of previous funds in fund's geography that the prospect has invested in from the fundraiser's organization;
Geographic distance between fundraiser's organization and the prospect.
Variables describing the relationship between the fundraiser and the prospect, and between the fundraiser and the prospect's investment team:
Number of previous meetings between the fundraiser and the prospect,
Number of previous meetings between the fundraiser and the prospect's investment team members while team members were at previous organizations.
Variables describing the fit between fund and prospect criteria.
A series of dummy variables (0 or 1) if there exists an investment size fit, first-time fund fit, and other criteria fit between the fund being raised and the prospect. For example, a dummy variable could represent whether the first-time fund (e.g. the fund is the first in the strategy being raised by the particular investment management firm) criteria is matched. If the prospect is fine with investing in a first-time fund and the fund being raised is indeed a first-time fund, the dummy variable value for that prospect in the estimation regarding that particular fund is set to equal 1. Otherwise, the dummy variable is set to equal 0.

The estimated investment amount in the fund for each prospect 404 is a non-negative numerical value with units in a currency such as dollars. The initial probability estimates come from parameters estimated employing publicly-available and commercially-available data, which can serve the routine that training data does. Future probability estimates are made using parameters estimated with additional data proprietary to the fundraiser. FIG. 3 provides an outline of the overall operation of one embodiment of the present invention with the iterative feedback loop.

The data proprietary to the fundraiser is garnered and received by mobile device 15 or server 25 over the course of the fundraiser's numerous meetings with numerous prospects over time. This data proprietary to the fundraiser consists of (1) updated data (such as a new asset allocation) learned during meetings useful to predicting a prospect's amount of investment that is more accurate than older publicly-available data, and (2) additional information useful to predicting a prospect's amount of investment not readily reflected in publicly-available data but learned during meetings (such as a new emphasis on a more concentrated portfolio of funds).

A latent regression model can be used to estimate a prospect's investment amount:

k*ᵢ=ρ+eᵢ
Where k*ᵢ is a latent (unobservable) variable reflecting investment amount, or committed investment amount, by prospect i into a particular fund being raised. The variable k*ᵢ is assumed to depend linearly on a vector of independent, exogenous variables mᵢ via a vector ρ. There is a normally distributed error term eᵢ˜N(0, σ²) to capture random influences.
Since investment amounts are not negative, the observable dependent variable kᵢ is left-censored at a value assumed to be zero in this description:

kᵢ=k*ᵢ if k*ᵢ>0, and

kᵢ=0 if k*ᵢ≦0
Since investment funds typically have minimum investment amounts in the thousands or millions of dollars, the actual censoring value employed in practice will likely be above zero.

Mobile device 15 or server 25 can use a Tobit model analysis, or similar method applicable to censored regression models in which observable variable kᵢ is defined to be equal to a latent variable k*ᵢ* if above zero (or another censoring value) and to be equal to zero otherwise. The Tobit model analysis employing maximum likelihood estimators, or similar method such as Type II Tobit models, is used to estimate the vector of parameters ρ. For each prospect i, the values of observations of kᵢ and vector of observations mᵢ will initially be populated from publicly available data. For some categories of investors, public data sources contain data on the amount that a particular fund investor i has invested, or committed to invest, in a particular fund. They also contain data on some characteristics of the investor mᵢ. With these initial data points, the parameters ρ can be estimated with maximum likelihood estimation or similar methods. Once the parameters p are estimated, a particular prospect's values for the explanatory variables that comprise mᵢ can be used by mobile device 15 or server 25 to estimate that prospect's k*ᵢ. In displaying estimated investment amounts, mobile device 15 or server 25 can will left-truncate k*ᵢ values to zero as needed, such that prospects estimated to invest negative amounts will be shown to have an estimated investment of zero, for example. Over time, each fundraiser will be able to add more observations of kᵢ and mᵢ based on the fundraiser's own meetings, observations, industry intelligence, etc. Each fundraiser may also be able to modify the vector of explanatory variables to be greater than or less than M variables based on experience or predictive power of the additional variables.

The vector of explanatory variables mᵢ can have five major categories of numerical and binary dummy variables that measure key characteristics including but not limited to:
Variables describing the prospect's general characteristics, and prospect's characteristics relevant to fund's strategy and geography:
Type of prospect (dummy variables indicating public pension, corporate pension, endowment, individual, etc.),
Prospect's assets under management,
Prospect's years of experience investing,
Prospect's target allocation for fund's strategy,
Prospect's actual allocations made to fund's strategy and geography;
Variables describing the prospect's overall investment team characteristics, and prospect's investment team characteristics relevant to fund's strategy and geography:
Size of investment team at prospect;
Size of investment team relevant to fund's strategy;
Use of non-discretionary consultant (dummy variable);
Tenure of the prospect's chief investment officer.
Variables describing the relationship between the fundraiser's organization and the prospect:
Number of previous funds that the prospect has invested in from the fundraiser's organization;
Number of previous funds in fund's strategy that the prospect has invested in from the fundraiser's organization;
Number of previous funds in fund's geography that the prospect has invested in from the fundraiser's organization;
Geographic distance between fundraiser's organization and the prospect.
Dollar amount of previous funds that the prospect has invested in from the fundraiser's organization;
Dollar amount of previous funds in fund's strategy that the prospect has invested in from the fundraiser's organization;
Dollar amount of previous funds in fund's geography that the prospect has invested in from the fundraiser's organization.
Variables describing the relationship between the fundraiser and the prospect, and between the fundraiser and the prospect's investment team:
Number of previous meetings between the fundraiser and the prospect,
Number of previous meetings between the fundraiser and the prospect's investment team members while team members were at previous organizations.
Variables describing the fit between fund and prospect criteria.
A series of dummy variables (0 or 1) if there exists an investment size fit, first-time fund fit, and other criteria fit between the fund being raised and the prospect. For example, a dummy variable could represent whether the first-time fund (e.g. the fund is the first in the strategy being raised by the particular investment management firm) criteria is matched. If the prospect is fine with investing in a first-time fund and the fund being raised is indeed a first-time fund, the dummy variable value for that prospect in the estimation regarding that particular fund is set to equal 1. Otherwise, the dummy variable is set to equal 0.

After displaying the records on prospects, mobile device 15 can then receives input on which prospect(s) to display more detailed information on. It then can display the full record of information on that prospect, including but not limited to the following:
Name of Prospect
Probability of Investment
Estimated Investment Amount
Type of Fund Investor
Location
Geographies of Investment
Strategies of Investment
Minimum Investment Amount
Target Fund Sizes
Investment Characteristics
Investment Volume in the Last 12 Months
Contact Person(s)
Contact Information
Fundraiser's Previous Funds Invested In and Amounts
Subsequently, mobile device 15 can receive input through the user interface 18 on which prospect records to store for future use 405 and reference in Investors Module 210.

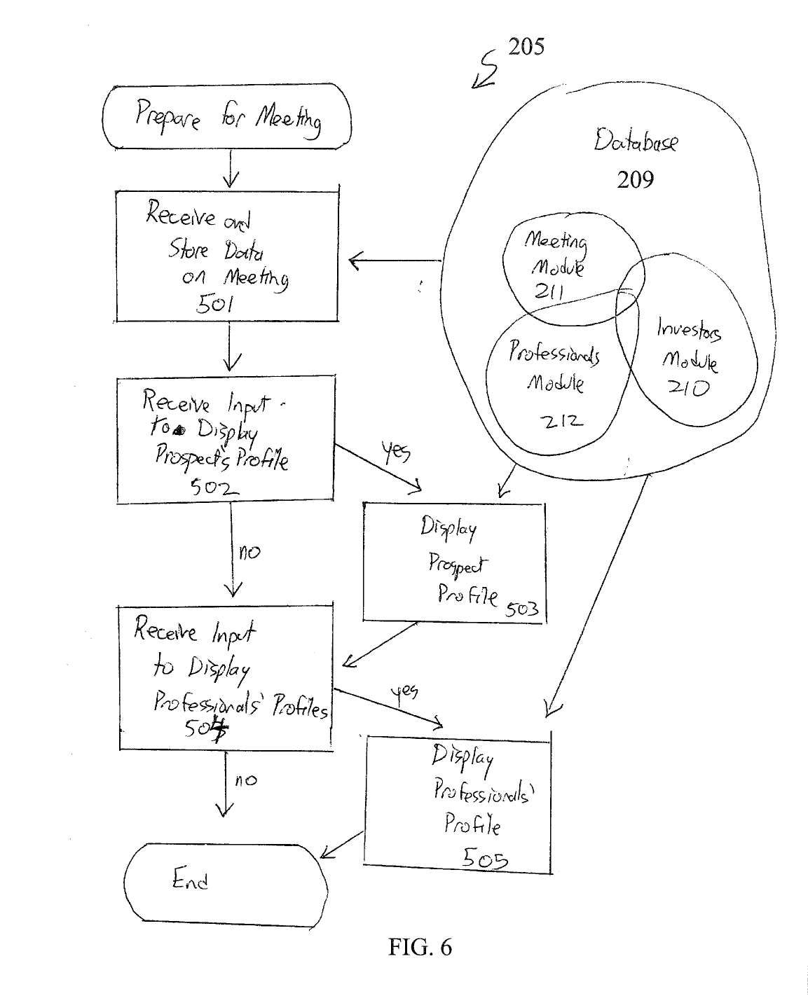

FIG. 6 is a flow diagram showing an exemplary prepare for meeting process of one embodiment of the present invention. When mobile device 15 receives input to initiate Prepare for a Meeting 205, mobile device 15 collects key data relevant to the user's preparation for a meeting, transitioning Prospects 102 to Prospects Met 103. Mobile device 15 or server 25 can employ Prepare for Meeting 205 in conjunction with the Find

Prospects 203 and Quantify Prospects 204, or independently from the Find Prospects 203 and Quantify Prospects 204.

Upon activation, mobile device 15 displays a screen and receives input for key particulars about the meeting, including but not limited to the following: date of meeting, and name of prospect. This information opens and populates a record for the meeting. Upon receiving user input, mobile device 15 can then search on the user's computer appointment system or server 25 for information on the names and titles of meeting participants, as well as their organizations 501. If the user's appointment system does not contain such information, mobile device 15 can request and accept manual input on the names and titles of meeting participants. Mobile device 15 can then present a results screen that shows, in tabular form, the prospect to be met, as well as the names, titles, and organizations of the meeting participants representing the prospect. Mobile device 15 can display a prompt next to each organization's entry asking if the user would like a summary of that prospect. If mobile device 15 receives a request that a professional summary of a particular prospect at the meeting is desired 502, then mobile device 15 can search Investors Module 210 created in Find Prospects 203 for information on the prospect and displays the prospect's profile 503. If the particular prospect does not have a record in Investors Module 210, mobile device 15 can then search the major search engines, social media sources, and industry databases for key background information on (1) the prospect to be met, and (2) the professionals representing the prospect at the meeting.

On a new page, mobile device 15 can then display a concise summary of that organization, including but not limited to the following information, where available:
Name of Prospect
Probability of Investment
Estimated Investment Amount
Type of Fund Investor
Location
Geographies of Investment
Strategies of Investment
Minimum Investment Amount
Target Fund Sizes
Investment Characteristics
Investment Volume in the Last 12 Months

If the prospect did not previously have a record in Investors Module 210, mobile device 15 or server 25 can create and save a record in Investors Module 210 for that prospect. Mobile device 15 can then returns to the meeting's prospect/professionals results page. Underneath the prospect listing section, mobile device 15 can display a prompt next to a meeting participant's entry asking if the user would like a professional summary of that person. Mobile device 15 can receive input 504.

If mobile device 15 receives input that a professional summary of a particular meeting participant is desired, then mobile device 15 or server 25 can search Professionals Module 212 for information on the particular professional and displays the relevant professional's profile 505. If the particular professional does not have a record in Professionals Module 212, mobile device 15 or server 25 can then search the major search engines, social media sources, and industry databases for key background information on that meeting participant.

On a new page, mobile device 15 can then present a concise summary of that person, including but not limited to the following information, where available:
Name of Professional
Organization
Title
Department/Role
Contact Information
Geographies of Investment
Strategies of Investment
Previous Relationship with Fundraiser
Professional Background
Educational Background

If the professional did not previously have a record in Professionals Module 212, mobile device 15 or server 25 can create and save a record in Professionals Module 212 for that person. Mobile device 15 can then return to the meeting prospects and professionals results page. When mobile device 15 no longer receives input that a summary of organizations at the meeting or meeting participants is desired, mobile device 15 can store the organizational and professional profile information in Database 209. It then returns to the main menu.

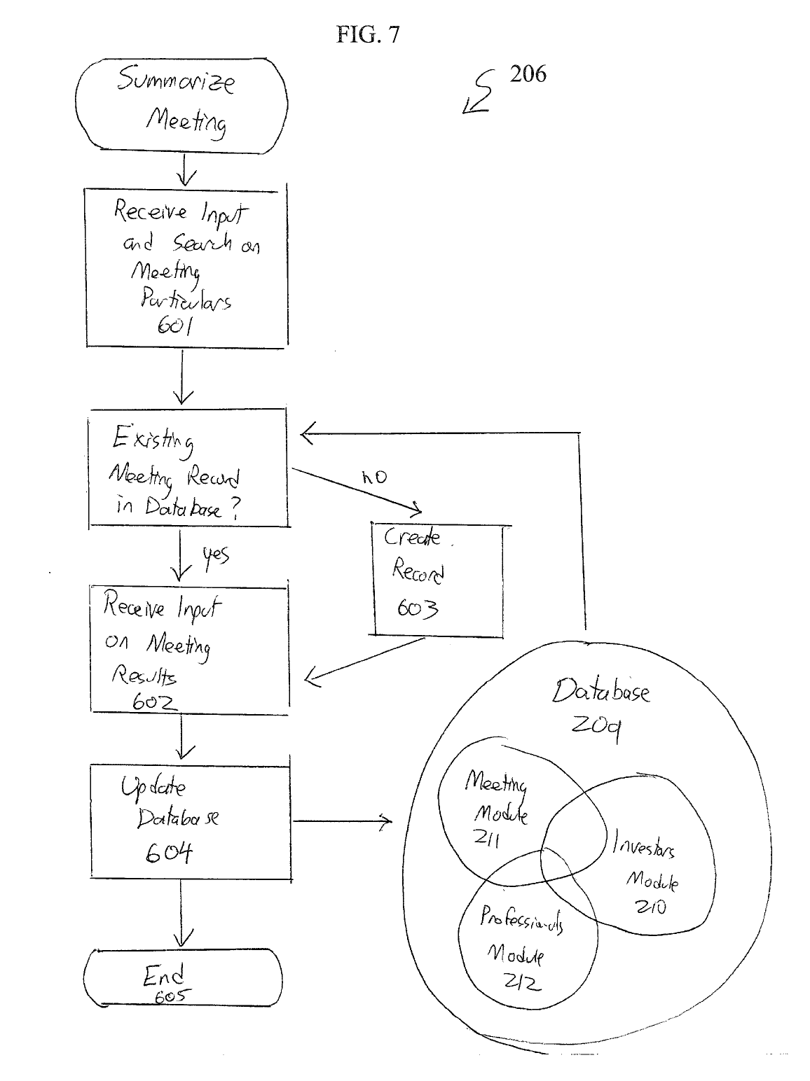

FIG. 7 is a flow diagram showing an exemplary summarizing meeting process of one embodiment of the present invention. When mobile device 15 receives input, it initiates Summarize Meeting 206. Summarize Meeting 206 may be synchronized with the meeting information already stored in Meetings Module 211 through Prepare for Meeting 205. When Summarize Meeting 206 is activated, mobile device 15 initially prompts the user to input particulars about the search terms. With the search terms, mobile device 15 or server 25 can search Database 209, particularly Meetings Module 211, for matching items such as the meeting date, place, prospect, and/or professionals in attendance 601. Mobile device 15 prompts for and accepts input on search terms in a manner akin to that of the major Internet search engines. The search Database 209 can be open-ended and not confined to entering the appropriate term in narrowly defined, pre-specified fields, thereby allowing the record of a previous meeting to be located by the meeting's date, fund discussed, the attendees, the location, or some other manner.

If mobile device 15 or server 25 is able to locate an existing record in Meetings Module 211 for a particular meeting, the routine proceeds to receive input on meeting results 602. If mobile device 15 or server 25 is not able to locate a record in Meetings Module 211 for the particular meeting, mobile device 15 or server 25 proceeds to create a new record 603 in Meetings Module 211. In creating a new record of a meeting, mobile device 15 or server 25 requests and receives input on when the meeting took place. It then searches the user's computer-based or mobile-based meeting calendar for that day. Mobile device 15 then displays a table of the meetings for that day that it has found. Mobile device 15 prompts the user to select which meeting to provide input for. When mobile device 15 receives input for one of the meetings in the table, the meeting place input screen is automatically populated with that particular meeting's date, time, place, participants, and other information loaded from the user's computer-based or mobile-based meeting calendar. If needed, mobile device 15 requests manual user entry of the meeting attendees' names, titles, prospect, and other particulars needed to complete a basic record for Meetings Module 211 and other modules. After creation of and basic population of a record for Meetings Module 211, mobile device 15 then proceeds to receive input through the user interface 18 on meeting results 602.

After the basic record of a meeting has been located or created, mobile device 15 receives input on meeting results, including fundraiser impressions, findings, and follow-up steps. Through user interface 18, mobile device 15 generates and employs a sliding scale, employing a numerical or similar scale, or similar input method to allow the user to quantitatively rate the effectiveness of the meeting along a numerical rating scale. Mobile device 15 then accepts input on the fundraiser's assessment of how successful the meeting was.

The findings cover each fund discussed at the meeting. Mobile device 15 can request and receive input on each fund discussed at the meeting. Then, for each fund discussed at the meeting, mobile device 15 can request and receive input via the user interface 18, information on the user's assessment of: the likelihood of a particular prospect's investing in each particular fund (a numerical assessment from 0% to 100%),
the potential investment amount for that fund (a numerical value),
the key attributes of a particular fund of interest to the prospect (from the mobile-displayed menu of track record, strategy, platform, return profile, etc.), receiving these inputs via sliding scale, buttons, typing, or similar mechanism;
the prospect's key concerns of a particular fund (from the mobile-displayed menu of track record, fund size, team stability, financial terms, timing of raise, etc.), receiving these inputs via sliding scale, buttons, typing, or similar mechanism;
other relevant metrics that represent the information learned during the meeting, particularly any variables that may affect the probability of investment (such as a new asset allocation or a preference for funds headed by alumni of certain investment banks) and/or the amount of investment (such as a new emphasis on a concentrated fund portfolio).
These additional data items can be employed by machine-learning algorithms to discern usefulness for incorporating into future.

Mobile device 15 then collects information from the user on next steps that the user may need to take with the prospect. Mobile device 15 then presents a screen requesting input on next steps. The screen is populated with certain key responses, including Call, Meet Again, Email Further Information, Provide Data Room Access, Nothing, etc. Mobile device 15 also allows manual user entry of follow-up steps.

If the option to Call is selected, mobile device 15 prompts the user to provide information on whom should be called. If the option to Email Further Information is selected, mobile device 15 prompts the user to provide information to which further information should be emailed as well as to specify what type of information, such as a private placement memorandum. If the option to Provide Data Room Access is selected, mobile device 15 prompts the user to provide information on which fund's data room is to be opened and for whom. Mobile device 15 then collects information on the timing of each of the next steps. For each next step specified by the user, mobile device 15 requests input on when that particular next step should take place. It accepts input in the form of a selection from a graphical calendar or similar means, so that the day of the week, etc. can be apparent. Mobile device 15 then receives input on the date to take the next step from a calendar. As described below, on that day, mobile device 15 then automatically reminds the fundraiser and supplies all the necessary info needed by the fundraiser to implement the next steps.

Mobile device 15 then may request and accept input on whether the user wishes to update information in Investors Module 210 or Professionals Module 212 as a result of the meeting 604. Upon receiving input on modules to update, mobile device 15 then proceeds to display prospects and professionals associated with a meeting, and receives updated information or additional information to be stored in each prospect's or professional's record. In particular, mobile device 15 requests input on whether the user seeks to upload photographs of the professionals in the meeting and/or their business cards, which may have been taken at or collected during the meeting. Drawing from the database 209 records of the meeting, mobile device 15 displays the names and titles of the meeting's participants—the professionals of the prospect organization—and accepts input on which ones to attach photographic reminders to.

Upon receiving input from the user, mobile device 15 then displays the available information for each meeting participant and accepts input on what photographic material to associate with that record. The photographic material may include photographs of the professional resident on the portable device or desktop computer that can be uploaded, photographs of the professional drawn from a social media or other Internet source, photographs of the professional's business card, or other similar materials. Upon completion of receiving information on meeting feedback, follow-ups, and new information, Summarize Meeting 206 updates the relevant modules of the database 604. These modules include Meetings Module 211, Investors Module 210, and Professionals Module 212. Mobile device 15 subsequently returns to the main menu after ending 605.

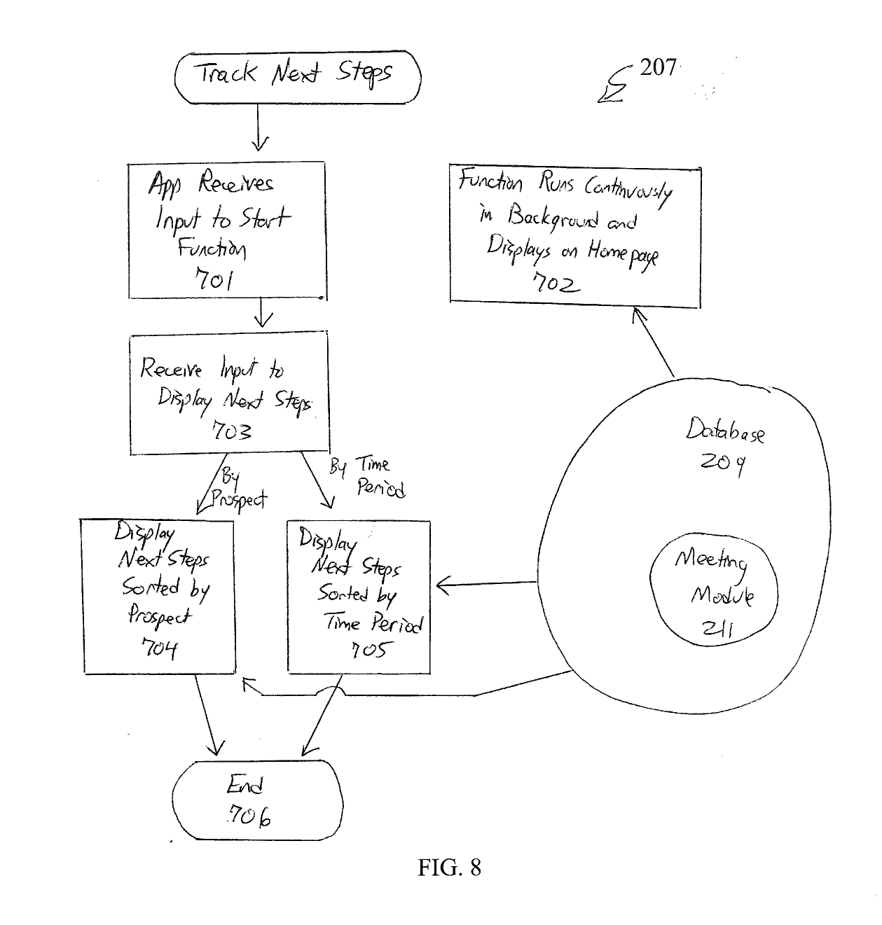

FIG. 8 is a flow diagram showing an exemplary track next steps process after a meeting or similar interaction of one embodiment of the present invention. After a meeting or interaction, action by the fundraiser is typically required within a particular timeframe; they may include but are not limited to emailing a prospectus or private placement memorandum (PPM) to the prospect, scheduling a follow-up meeting, arranging a call, providing data room access (access to a secure online website from which the prospect can access key documents related to the fundraising), and similar follow-up measures.

In addition to being activated by mobile device 15 receiving input 701, Track Next Steps 207 can also run continuously in the background of mobile device 15 even without user input 702. The homepage on mobile device 15 displays the results of continuously-running Track Next Steps 207 in a regularly-updated reminder on the homepage on mobile device 15 of any follow-up steps that need to be taken that day, or any similar preset period (e.g. all follow-ups needed in the next week) for which a reminder is needed in advance. Track Next Steps 207 draws upon information for prospects that mobile device 15 received in Summarize Meeting 206. Mobile device 15 or server 25 can synchronize this information on follow-up items and timeframes with a mail server application, calendar application, or similar application on the portable or desktop device. Thus, mobile device 15 is able to remind the fundraiser on the homepage if some follow-up needs to be done today or some other preset reminder interval.

Upon the activation 701 via the user interface 18, mobile device 15 requests and receives input on whether to display follow-up steps by prospect or by time period 703. If mobile device 15 receives input through user interface 18 that follow-ups by prospect should be displayed 704, mobile device 15 can accept input on which prospect to display follow-ups for. Upon receiving input on the prospect to display follow-up steps for, mobile device 15 can access and display information in tabular or similar form. This information can be sorted by the prospect organization, and can provide each of the next steps necessary for that prospect, the professional or professionals at the prospect to follow up with, and the timeframe for the follow-up action. Mobile device 15 can request and receive input on whether to display further information about a particular follow-up action. If such input is received, mobile device 15 can display details of the action required today plus any needed information to execute, such as phone number for a follow-up call.

If mobile device 15 receives input that follow-ups by timeframe should be displayed 705, mobile device 15 can display a calendar and accept input on the earliest date and the latest date of the follow-ups for which information is requested. After receiving the input on the timeframe of the follow-ups for which information is requested, mobile device 15 can then display information in tabular or similar form. This information can be sorted by date of the required follow-up, the prospect organizations for which follow-up actions are required within that timeframe, the next steps necessary for that prospect within that timeframe, the professional or professionals at the prospect to follow up with, and any other relevant items. When mobile device 15 no longer receives input that information about next steps is desired, it can exit and returns to the main menu 706.

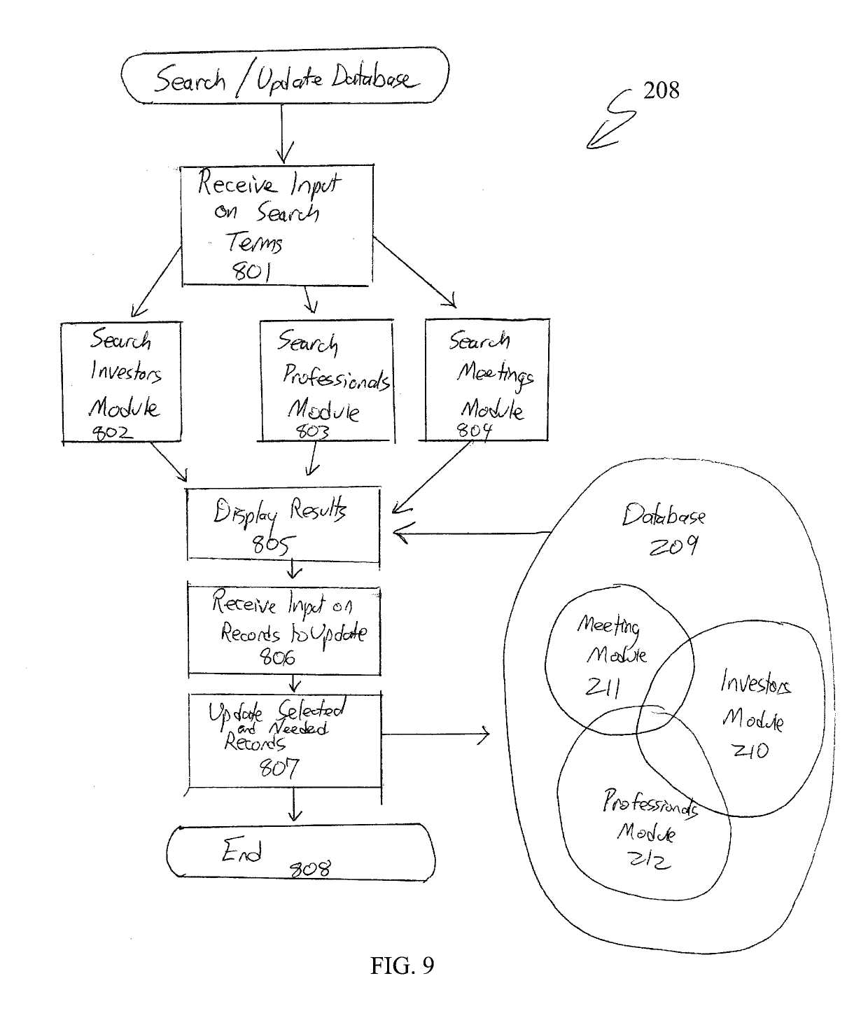

FIG. 9 is a flow diagram showing an search and update database process of one embodiment of the present invention. From the main screen, if mobile device 15 receives a request to Search Database, mobile device 15 starts Search/Update Database 208. Mobile device 15 can prompt for and accept input on search terms of interest to the fundraiser in a manner akin to that of the major Internet search engines 801. The search on database 209 can be open-ended and not confined to entering the appropriate term in narrowly defined, pre-specified fields. Database 209, with its modules, can be proprietary to the fundraiser, having been created over time in the course of using mobile device 15 to record meetings and other interactions with prospects and fund investors. After receiving input on the search term, mobile device 15 can search all the interconnected modules of its database, including but not limited to Investors Module 210, Professionals Module 212, and Meetings Module 211. Mobile device 15 can then display a summary table of the results, broadly disaggregated into the groupings of prospects, fund investors, professionals, and meetings 805.

For each investor, mobile device 15 can display information that may include, but not be limited to, the following:
Name of Prospect
Probability of Investment
Estimated Investment Amount
Type of Fund Investor
Location
Geographies of Investment
Strategies of Investment
Minimum Investment Amount
Target Fund Sizes
Investment Characteristics
Investment Volume in the Last 12 Months
Fund Investor in Previous Funds from Fundraiser?

For each professional, mobile device 15 can then display a concise summary of that person's record in Professionals Module 212, including but not limited to the following information, where available:
Name of Professional
Organization
Title
Department/Role
Contact Information
Geographies of Investment
Strategies of Investment
Previous Relationship with Fundraiser
Professional Background
Educational Background

For each meeting, mobile device 15 can display information that may include, but not be limited to, the following:
Date of Meeting
Location of Meeting
Organizations Represented at Meeting
Professionals Attending Meeting
Fund(s) Discussed at Meeting
Follow-ups From Meeting

Mobile device 15 can then receive input about which investor, professional, or meeting record to display further information on. This further information can represent the underlying entry corresponding to the summary record selected. In the course of displaying records from database 209, mobile device 15 can also display on the screen a way to accept input that the user seeks to update or expand information contained in a particular record 806. Upon receiving input that a particular record needs to be updated, mobile device 15 can then update the necessary field in the record and saves the updated record 807 in the relevant module or modules in Database 209.

In particular, mobile device 15 can receive input that one of the Prospects Met 103 has become a Fund Investor 104. It then records the transition of Prospects Met 103 to Fund Investors 104, and the successful completion of the fundraising process involving a particular prospect and particular fund.

If Fund Investor is a first-time Fund Investor with the fundraising organization because it has not invested in the fundraising organization's previous funds, then mobile device 15 or server 25 can record new information to the organization's record in

Database 209, particularly in Investors Module 210, regarding the fund invested in and amount 807.

If the organization is an existing Fund Investor with the fundraising organization because it has invested in the fundraising organization's previous funds, then mobile device 15 or server 25 can record further information to the organization's record in the Database 209, particularly in Investors Module 210, regarding the additional fund invested in and amount 807.

In addition, mobile device 15 can have a flexible input architecture so that it can accept input in Search/Update Database 208 information on new variables or factors that the fundraiser believes affect the likelihood of investing and/or the amount of investment. Mobile device 15 or server 25 can have utilize machine learning techniques that subsequently ascertain whether these additional factors would have predictive power. Determination of the existence of predictive power of the additional factors would rely on tests of statistical significance of the additional variables in a multivariate regression estimation employing the relevant data.

When mobile device 15 no longer receives input that information about search results or that further searches is desired, it exits and returns to the main menu 808.

Mobile device 15, server 25 and database 209 can help fundraisers with systematically identifying prospects, quantifying the likelihood of these prospects becoming fund investor investors, quantifying the estimated investment amount of each prospect, and systematically employing information gleaned from prospect meetings to iteratively fine-tune the process of identifying prospects and quantifying the likelihood of conversion (from prospect to fund investor in the fund).

Quantifying the likelihood of prospect conversion in the fundraising process and quantifying the estimated investment amount of each prospect allow the fundraiser to optimally allocate resources during the resource-intensive process of contacting, arranging and conducting meetings with prospects, and guiding prospects through a relationship-building and fundraising process that can stretch for years. In particular, there are few ways to support fundraisers where they most often find themselves—on a business trip away from the office and away from their desktop computers which may contain most of their software used to support fundraising. This situation calls for a computer application that can be downloaded onto mobile or similar portable devices, an app, that can quickly and simply allow fundraisers to track the results and progress of meetings with prospects while the fundraisers are still on their business trips. The usage of an app on handheld portable or similar devices allows fundraisers to quickly record notes from meeting prospects or fund investors soon after the event, possibly several days before returning to the office and before recollection fades regarding important discussion points or follow-up action items. Once fundraisers returns to their offices, the data collected and already recorded in the app can be synchronized with desktop computer software for analysis or backup. The app would also allow ready export of data to a larger desktop-based CRM or fundraising software package, and then compute analytics to assess fundraising strategy effectiveness and to refine the statistical model for prospect identification.

In addition to being useful to fundraisers, the embodiments of the present invention is applicable to other professionals who participate in fundraising or similar marketing processes involving a significant number of meetings or similar interactions. These professionals include the prospective investors (prospects) or buyers who may also meet numerous fundraisers or marketing professionals, and who would utilize many functions of one embodiment of the present invention—particularly those involving preparing for meetings, summarizing meetings, and tracking follow-up next steps—while on business trips.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for fundraising tracking and synchronization comprising:
a user interface configured to allow input from a user;
a display configured to display information to said user;
a processor coupled to said user interface and said display configured to process said input and said information;
a meeting summarization module coupled to said processor configured to receive fundraising meeting information from said user and prompt said user for fundraising next steps;
a tracking module coupled to said processor configured to track said fundraising next steps; and
a transceiver coupled to said processor configured to transfer said information with a server.

2. The system of claim 1 further comprising:
a prospect identification module configured to identify a fundraising prospect based on fund characteristics and investor characteristics.

3. The system of claim 1 further comprising.
a prospect quantification module configured to estimate a probability of investment from a fundraising prospect.

4. The system of claim 1 further comprising.
a prospect quantification module configured to estimate an amount of investment from a fundraising prospect.

5. The system of claim 1 further comprising:
a meeting preparation module configured to collect information for a fundraising meeting.

6. The system of claim 1 further comprising:
a database interface module configured to search a database for information stored on said database.

7. The system of claim 1 further comprising:
a database interface module configured to update information stored on a database.

8. A method for fundraising tracking and synchronization comprising:
searching for a record of a fundraising meeting;
requesting a user to input a result of said fundraising meeting;
requesting said user to input a next step after said fundraising meeting;
updating a database with said result of said fundraising meeting updating said database with said next step after said fundraising meeting; and
tracking said next step.

9. The method of claim 8 further comprising:
identifying a fundraising prospect from a plurality of eligible investors for a fund.

10. The method of claim 8 further comprising:
identifying a fundraising prospect from a plurality of eligible investors for a fund by matching characteristics of said fund with portfolio needs of said eligible investors.

11. The method of claim 8 further comprising:
calculating a likelihood of a fundraising prospect investing into a fund.

12. The method of claim 8 further comprising:
calculating an estimated investment amount from a fundraising prospect into a fund.

13. The method of claim 8 further comprising:
transmitting a reminder to said user for said next step.

14. The method of claim 8 further comprising:
transmitting a reminder to said user to send a private placement memorandum.

15. The method of claim 8 further comprising:
using multivariate regression to calculate a likelihood of a fundraising prospect investing into a fund.

16. The method of claim 8 further comprising:
using multivariate regression to calculate an estimated investment amount from a fundraising prospect into a fund.

17. The method of claim 8 further comprising:
associating a photograph to a record of a participant of said fundraising meeting.

18. The method of claim 8 further comprising:
storing an image of a business card of a participant of said fundraising meeting.

19. The method of claim 8 further comprising:
requesting said user to input information learned from said fundraising meeting; and
storing said information learned from said fundraising meeting in said database.

20. The method of claim 8 further comprising:
requesting said user to input potential investment amount from a fundraising prospect; and
storing said potential investment amount in said database.
